(19) United States
(12) Patent Application Publication
(10) Pub. No.: US 2023/0166252 A1
(43) Pub. Date: Jun. 1, 2023

(54) LATERAL FLOW TEST KITS

(71) Applicant: EMED LABS, LLC, Miami, FL (US)

(72) Inventors: Zachary Carl Nienstedt, Wilton Manors, FL (US); Adam Charles Carlson, Miami, FL (US)

(21) Appl. No.: 18/059,649

(22) Filed: Nov. 29, 2022

Related U.S. Application Data
(60) Provisional application No. 63/284,550, filed on Nov. 30, 2021.
(60) Provisional application No. 63/284,402, filed on Nov. 30, 2021.

(51) Int. Cl. B01L 3/00

(52) U.S. Cl. CPC B01L 3/502715; B01L 3/5029; B01L 3/5023; B01L 2200/0689; B01L 2300/0825; B01L 2400/06; B01L 2300/0832; B01L 2300/042; B01L 2300/044; B01L 2200/141

(57) ABSTRACT

Lateral flow devices and methods are described. In one example, a device includes body extending between a first end and a second end. The body holds a liquid. The device also includes a swab extending from the first end of the body, a lateral flow test strip extending from the second end of the body, a first tube removably attached to the first end of the body and covering the swab, and a second tube removably attached to the second end of the body and covering the lateral flow test strip. The first end of the body includes a first valve that can be selectively opened by a user, and the second end of the body comprises a second valve that can be selectively opened by the user.

### PRIORITY APPLICATIONS

This application claims priority to U.S. Provisional Patent Application No. 63/284,402, filed Nov. 30, 2021, and to U.S. Provisional Patent Application No. 63/284,550, filed Nov. 30, 2021, each of which are incorporated herein by reference. Any and all applications for which a foreign or domestic priority claim is identified in the Application Data Sheet as filed with the present application are hereby incorporated by reference under 37 CFR 1.57.

### BACKGROUND

### Field

The present application is directed to systems, methods, and devices that can be configured to optimize lateral flow test designs for home use, such as a test used during remote medical testing and diagnostics.

### Description

Use of telehealth to deliver healthcare services has grown consistently over the last several decades and has experienced very rapid growth in the last several years. Telehealth can include the distribution of health-related services and information via electronic information and telecommunication technologies. Telehealth can allow for long-distance patient and health provider contact, care, advice, reminders, education, intervention, monitoring, and remote admissions. Often, telehealth can involve the use of a user or patient's personal user device, such as a smartphone, tablet laptop, personal computer, or other device. For example, a user or patient can interact with a remotely located medical care provider using live video, audio, or text-based chat through the personal user device. Generally, such communication occurs over a network, such as a cellular or internet network.

Remote or at-home healthcare testing and diagnostics can solve or alleviate some problems associated with in-person testing. For example, health insurance may not be required, travel to a testing site is avoided, and tests can be completed at a testing user's convenience. However, remote or at-home testing introduces various additional logistical and technical issues, such as guaranteeing timely test delivery to a testing user, providing test delivery from a testing user to an appropriate lab, ensuring adequate user experience, ensuring proper sample collection, ensuring test verification and integrity, providing test result reporting to appropriate authorities and medical providers, and connecting testing users with medical providers who are needed to provide guidance and/or oversight of the testing procedures remotely.

### SUMMARY

Usability of a lateral flow test kit may be important for medical diagnostic testing. In some instances, the user may have to administer a medical diagnostic lateral flow test kit themselves, such as in a remote medical diagnostic test setting. In some instances, the lateral flow test design may benefit from being optimized for home use. For example, the lateral flow test design can be optimized for home use by minimizing the number of test steps, minimizing the number of parts within the test, providing the test at a low cost, minimizing the size of the test itself, and ensuring readable results (e.g., results that are easily readable by a user or by smartphone camera). In some instances, a component of the lateral flow test kit may be designed to promote usability while maintaining its ability function as a medical diagnostic test.

Embodiments of this application can provide a lateral flow test design that can be used to administer a medical diagnostic test. For example, a user may use a swab within the lateral flow test kit component to collect a biological sample from the user's nostril or other orifice. The lateral flow test kit component may include a tube that may then be positioned around the swab to secure it to a threaded lid of the lateral flow test component at the base of the swab. The user may twist the threaded lid at the base of the swab to open a valve within the lateral flow test kit component. In some embodiments, the user may turn the instrument upside down to allow fluid or reagent located within the inner tube of the lateral flow test component to pour into the tube surrounding the swab. In some embodiments, this may allow the swab to soak in the fluid for a predefined amount of time. Similarly, the user may twist a threaded lid located at the base of the lateral flow strip to open the valve. In some embodiments, the user may turn the instrument upside down to allow fluid or reagent to pour into the tube surrounding the lateral flow test strip. In some embodiments, this may allow the lateral flow strip to soak in fluid for a predefined amount of time. In some embodiments, the lateral flow test kit component may then be turned upside down once again and allow the user to remove the tube surrounding the lateral flow strip to allow the test results to develop.

In some embodiments, an unopened lateral flow test kit component may be utilized with the swab initially positioned pointed upward. In some embodiments, the top cap may be unscrewed to allow the user to swab both nostrils with a swab provided within the lateral flow test kit. Similarly, the bottom tube may be unscrewed from the lateral flow test body and the user may flip the test body. In some embodiments, the swab may be inserted into the bottom tube and the test body may be screwed to the tube that may secure the two components together. In some embodiments, the tube may be set aside to allow the medical diagnostic test results to develop. This can, for example, beneficially create the opportunity for lateral flow test kits to be used in a remote medical diagnostic test setting.

In other examples, a lateral flow test kit can include a cassette, including a test strip (e.g., a lateral flow strip) and a swab, and a cover configured as a test tube. The cover can include a pre-filled buffer solution. During use, a user may remove a lid from the test tube and place the test tube in a tube holder. In some embodiments, the user may remove the cassette from the foil pouch, wherein the swab may be integrated with the cassette. The user may then user the swab to swab both nostrils or other orifices.

In some embodiments, the user may hold the test tube and insert the swab into the test tube and screw the cassette onto the test tube. In some embodiments, this will allow the swab to be immersed in fluid or reagent that is contained within the test tube. In some embodiments, the user may pierce the test tube foil seal with the swab. In some embodiments, the user may continue to push the swab into the test tube until an audible click is heard and the swab is fully immersed in the solution. In some embodiments, this will allow the swab to be immersed in fluid or reagent that is contained within the test tube.

In some embodiments, the user may allow the cassette and test tube combination to sit for a predetermined amount of time. In some embodiments, the user may then read the result after the predetermined amount of time.

For purposes of this summary, certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

All of these embodiments are intended to be within the scope of the invention herein disclosed. These and other embodiments will become readily apparent to those skilled in the art from the following detailed description having reference to the attached figures, the invention not being limited to any particular disclosed embodiment(s).

### BRIEF DESCRIPTION OF THE DRAWINGS

FIG. 1 illustrates an embodiment of a lateral test flow kit component with a lateral flow strip.

FIG. 2 is a diagram illustrating an example lateral test flow kit protocol or method.

FIG. 3 illustrates an embodiment of a double tube lateral test flow kit component.

FIG. 4 is a diagram illustrating an embodiment of a double tube lateral test flow kit protocol or method.

FIG. 5 illustrates an example threaded cassette embodiment of a lateral flow test kit component.

FIG. 6 is a diagram illustrating an example threaded cassette embodiment lateral flow test protocol or method.

FIG. 7 illustrates an example minimum touch cassette embodiment of a lateral flow test kit component.

FIG. 8 is a diagram illustrating an example minimum touch cassette embodiment lateral flow test protocol or method.

FIG. 9 illustrates an example tamper prevention of a minimum touch cassette embodiment of a lateral flow test kit component.

FIG. 10 illustrates an example minimum touch cassette module of a lateral flow test kit component.

FIG. 11 is a diagram illustrating an example minimum touch cassette module assembly or manufacturing method or protocol.

FIG. 12 illustrates an example of components provided in a box presented to a user.

FIG. 13 is a diagram illustrating an example minimum touch cassette module lateral flow test protocol or method.

FIG. 14 is a diagram illustrating an example minimum touch cassette module working principal protocol or method.

FIG. 15A-15B illustrate an example stand accessory.

FIG. 16 illustrates an example horizontal self-support mechanism.

FIG. 17 illustrates an example vertical self-support mechanism.

FIG. 18 illustrates an example computer vision enhanced results interpretation mechanism.

### DETAILED DESCRIPTION

Although several embodiments, examples and illustrations are disclosed below, it will be understood by those of ordinary skill in the art that inventions described herein extend beyond the specifically disclosed embodiments, examples, and illustrations and includes other uses of the inventions and obvious modifications and equivalents thereof. Embodiments of the inventions are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

This application describes devices, systems, and methods for a lateral test flow kits, including double tube and cassette-based lateral flow test kits, such as a lateral test flow kit for at-home or remate health or diagnostic testing. Embodiments of the inventions described herein can comprise several novel features and no single feature is solely responsible for its desirable attributes or is essential to practicing the inventions described.

For example, in some instances, a test kit may be designed to allow a user to use a swab within a test tube to collect a biological sample from the user's nostril or other orifice. The user may position the tube around the swab and secure it to a threaded lid located at the based on the swab. The user may twist the threaded lid at the base of the swab to open the valve. The user may then turn the instrument upside down to allow fluid from the inner tube to pour into the tube surrounding the swab. This may allow the swab to soak in the fluid for a predefined amount of time. The user may then twist the threaded lid at the base of the lateral flow strip to open the valve. The user may turn the instrument upside down to allow the fluid to pour into the tube surrounding the lateral flow strip. This may allow the lateral flow strip to soak in fluid for a predefined amount of time. The user may then turn the instrument upside down once again and remove the tube surrounding the lateral flow strip to allow the test results to develop.

In some instances, for example, a test kit may be designed to allow a user to start with the unopened test kit. The test kit may be oriented to allow a swab within the test kit to be pointing up. The user may hold the test body while unscrewing the top cap of the test kit. The user may then swab both of the user's nostrils or other orifices. The user may hold the bottom tube of the test kit and unscrew the test it from the test body. The user may then flip the test body and insert the swab into the bottom tube. The user may then screw the test body onto the tube to secure the tube to the test body. The user may then place the tube in a tube holder and let it sit for a predetermined about of time before the user may read the result.

In general, many lateral flow tests are not particularly user friendly, especially for at-home users. In the past, lateral flow tests have been designed for lab use and may not be able to be used in a remote testing setting. This has led to at home test administration experiences that a user may find cumbersome and unintuitive. Accordingly, it may be beneficial to design lateral flow test kit components and/or assemblies for use by consumers rather than laboratory technicians. This may allow for enhanced usability and reliability of lateral flow test kit in a remote medical diagnostic testing setting. For example, in some cases, a lateral flow test kit component may be designed with a double tube to enhance a user's ability to use a lateral flow test kit in a remote medical diagnostic testing setting.

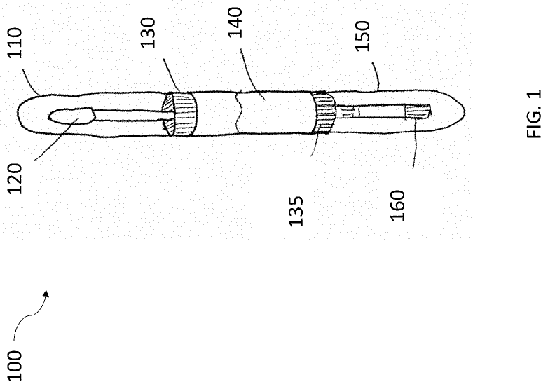

FIG. 1 illustrates an example design of a lateral test flow kit component 100 with a lateral flow strip 160. In this embodiment, the lateral flow test kit component 100 is configured as a double tube. The lateral flow test kit component may include a first tube 110 and a second tube 150. The first tube 110 may cover a swab 120 that may be located underneath the first tube 110. The swab 120 may be connected to a first lid 130 (e.g., to a fluid located within a body 140 of the component 100). A first lid 130 may be threaded to allow the first lid 130 to function as a twist valve. The lateral test flow kit component 100 may also include a lateral flow strip 160. The lateral flow strip 160 may be covered by the second tube 150. The lateral flow strip 160 may be connected to a second lid 135. The second lid 135 may also be threaded to allow the second lid 135 to function as a twist valve. The first lid 130 and second lid 135 may be connected by the body 140. The body may hold fluid or reagent that may be used during the administration of the medical diagnostic test.

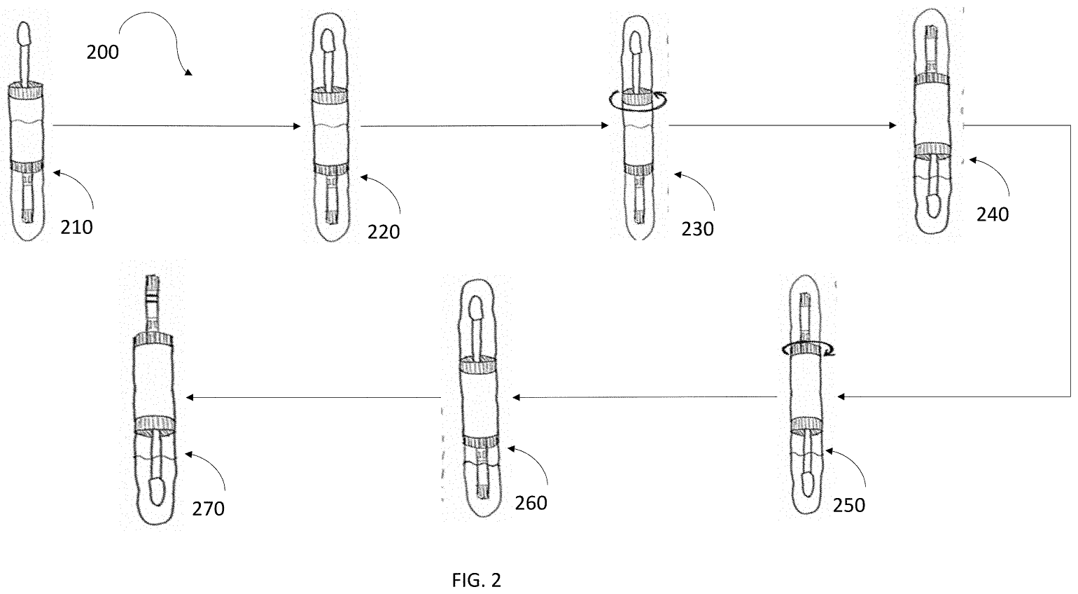

FIG. 2 is a diagram illustrating an example lateral flow test kit protocol or method 200. The method 200 may be configured to allow a user to administer a lateral flow medical diagnostic test in a remote setting. The method 200 may be implemented, for example, using one or more components of the system shown in FIG. 1.

At 210, the user may use a swab to collect a biological sample from the user's nostril or other orifice. For example, a cap covering the swab can be removed and the swab can be inserted into the nostril. At 220, the user may position the cap around the swab and secure it to the threaded lid. The threaded lid may be located at the base of the swab. Once secured, the swab may be located underneath a tube to keep the biological sample from contaminating other objects and to prevent outside elements from contaminating the biological sample.

At 230, the user may twist the threaded lid at the base of the swab to open the valve. Opening the valve may allow liquid or reagent held within an inner tube to spread throughout the component.

At 240, the user may turn the instrument upside down to allow the fluid or reagent from the inner tube to pour into the tube surrounding the swab. This may allow the swab to soak in fluid for a predefined amount of time.

At 250, the user may twist the threaded lid at the base of a lateral flow strip to open the valve. The valve prevents the fluid located within the inner tube from spreading to the lateral flow strip until the user is prepared. Upon twisting the valve, the fluid may spread to the lateral flow strip.

At 260, the user may turn the instrument upside down to allow the fluid to pour into the tube surrounding the lateral flow strip. This may allow the later flow strip to soak in fluid for a predefined amount of time.

At 270, the user may turn the instrument upside down once again and remove the tube surrounding the lateral flow strip. The lateral test strip may no longer be soaking in the fluid, but sufficiently coated with the fluid to allow the test results to develop. The user may then read the test results once they are developed on the lateral flow strip.

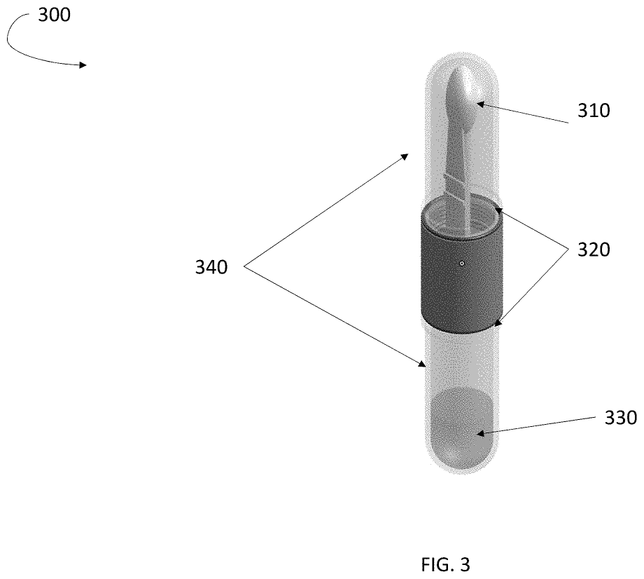

FIG. 3 illustrates an example design of a double tube lateral flow test kit component 300. The lateral flow test kit component 300 may include a swab and strip 310. The swab and strip 310 may be combined into a single part. The strip may include an absorbent region located under the foam swab. This may allow the swab to function as a “sock” over the end of the swab stick. The lateral test flow kit component 300 may include one or more O-rings 320. The O-rings may preserve a liquid seal and sterile properties located within the body of the component 300. The component 300 may include at least two clear tubes 340 located at either end of the component 300. The tubes may be used to cover the swab and strip 310 and hold a fluid or reagent 330. The tubes 340 may be identical on the swab 310 and the reagent side 330 of the component 300. The fluid or reagent may be a buffer solution. The buffer solution may be put into the tube 340 at the time of manufacturing of the tube. This use of identical tubes may allow part count reduction and a sterile seal on both sides of the component may allow for the test to be packaged in a paper pouch or other less expensive and easier packaging as opposed to a sterile foil pouch. Additionally, a snap off lid may be used to cover the swab, which may require the test to be packaged in a sterile foil pouch.

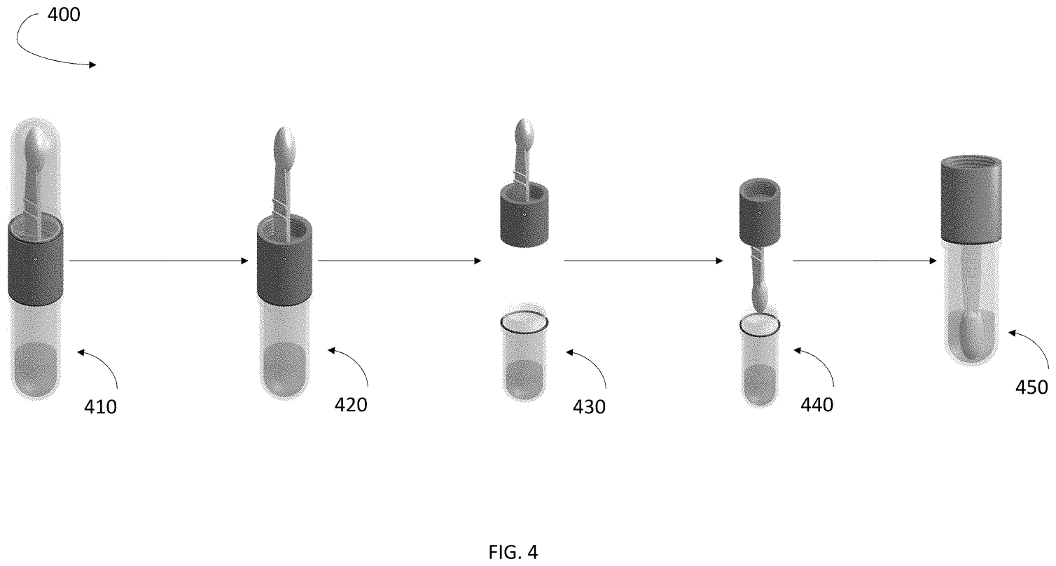

FIG. 4 is a diagram illustrating an example design of a double tube lateral test flow kit protocol or method 400. The method 400 may be configured to allow a user to administer a lateral flow medical diagnostic test in a remote setting. The method 400 may be implemented, for example, using one or more components of the system shown in FIG. 3.

At 410, the user may start with the unopened test, orienting the test tube in a direction for the swab to be pointing upward. At 420, the user may hold the test body in a manner that allows the user to unscrew the top cap. The user may then use the swab to swab both nostrils or other orifices.

At 430, the user may hold the bottom tube of the test and unscrew the test body. At 440, the user may flip the test body. This may orient the swab in a downward position that allows the swab to be inserted into the bottom tube. The bottom tube may contain a fluid or reagent that may be used during the administration of the medical diagnostic test.

At 450, the user may insert the swab into the bottom tube and screw the test body onto the tube to secure the test body to the bottom tube. The user may place the tube in a tube holder and let the tube sit for a predefined period of the time, approximately ten minutes. After a predefined period of time, the user may read the result of the medical diagnostic test.

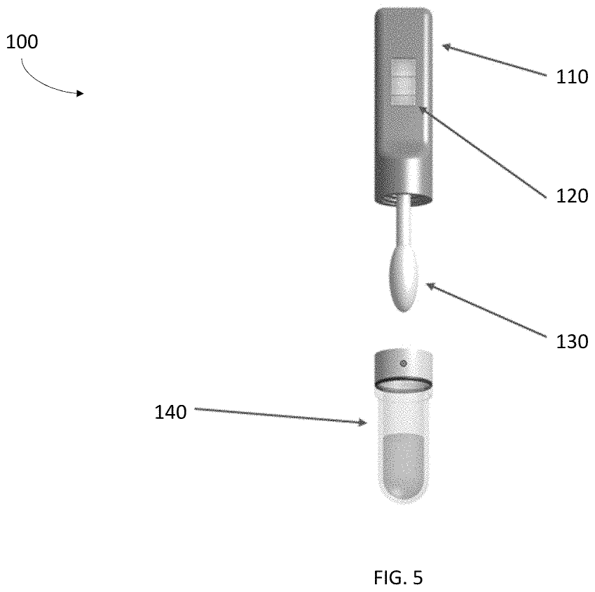

FIG. 5 illustrates an example threaded cassette design 100 of a lateral flow test kit component. The threaded cassette design 100 may include a cassette 110. The cassette 110 may include plastic housing that secures a strip 120 and a swab 130. Additionally, the cassette 110 may include threads for attaching the cassette 110 to a tube. The cassette 110 may include an integrated swab 130 and may be sealed in a foil pouch. The swab 130 may be attached to the test strip 120 in a manner that allows absorbed liquid to be transferred to the test strip 120. The test tube 140 may be pre-filled with a fluid or buffer solution. The test tube 410 may include an O-ring seal on threads to allow the O-ring seal to remain when the tube is attached to the threaded cassette.

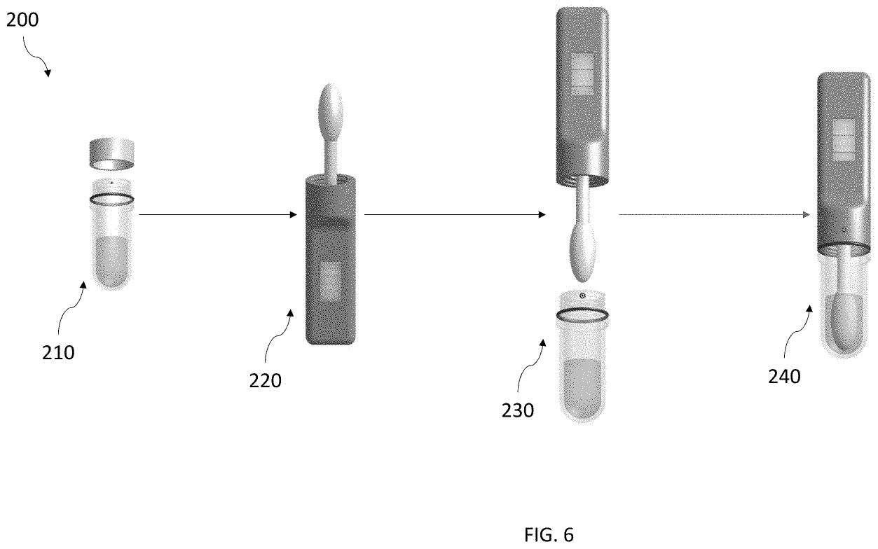

FIG. 6 is a diagram illustrating an example threaded cassette design lateral flow test protocol or method. The method 200 can be configured to allow a user to administer a lateral flow medical diagnostic test. The method 200 can be implemented, for example, using one or more components of the method shown in FIG. 6.

At 210, the user may remove the lid from the test tube and place the test tube in a tube holder. The test tube may include fluid or buffer solution, which the user may use during the administration of the lateral flow test.

At 220, the user may remove the cassette and swab from the foil pouch. Once removed, the user may use the swab to swab both nostrils or other orifices. At 230, the user may hold the test tube and insert the swab into the test tube. This may allow for the swab to be immersed in the fluid contained within the test tube. The user may screw the cassette onto the test tube.

At 240, the user may let the threaded cassette and test tube combination sit for a predetermine amount of time, approximately ten minutes. After a predetermined amount of time, the user may read the results of the lateral flow test.

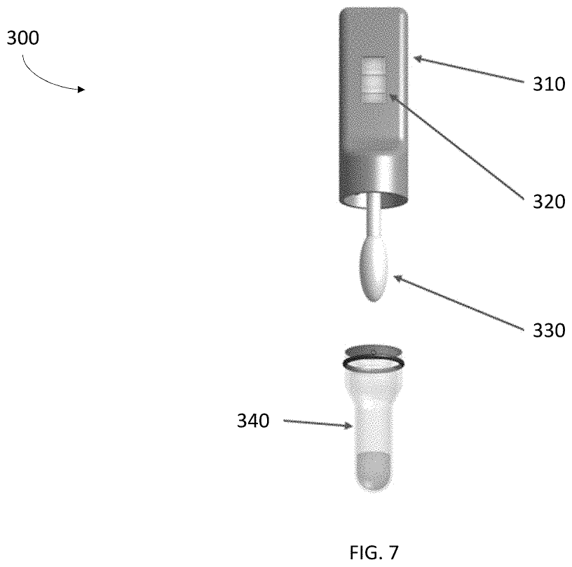

FIG. 7 illustrates an example minimum touch cassette design of a lateral flow test kit component. The minimum touch cassette 300 may include a cassette 310. The cassette 310 may include plastic housing that secures a test strip 320 and swab 330 to the cassette 310. The cassette 310 may further include clips for securing the test tube 340 to the cassette 310 and preventing tampering of the minimum touch cassette 300. The test tube 340 may be pre-filled with fluid or buffer solution and sealed with an adhesive foil cover. The test tube 340 may include an O-ring seal that may prevent fluid leakage after mating with the cassette 310. This may limit the chance that the fluid or buffer solution may be spilled accidentally. The minimum touch cassette design may be beneficial for a number of reasons. For example, there may only be two physical parts for the user to handle, there may be few steps to complete the lateral flow test, the tube may hold the required fluid or reagent for absorption, tamper prevention may be used via locking of the tube, the plastic parts may be able to be mass manufactured, the parts may be of small physical size (e.g., total length of approximately three inches), etc.

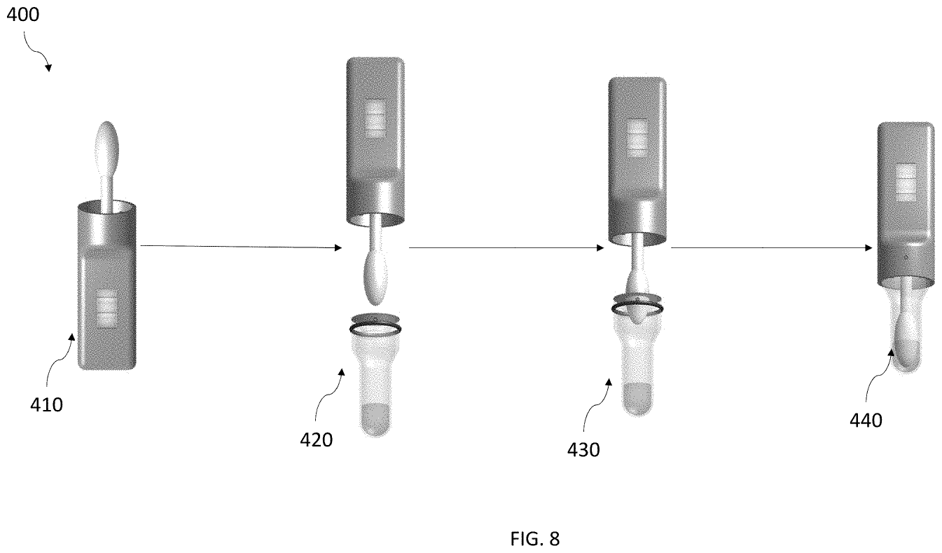

FIG. 8 is a diagram illustrating an example minimum touch cassette design lateral flow test protocol or method 400. The method 400 can be configured to allow a user to administer a lateral flow medical diagnostic test. The method 400 can be implemented, for example, using one or more components of the method shown in FIG. 8.

At 410, the user may remove the cassette from the foil pouch. The cassette may include a swab integrated with the cassette. The user may then use the swab to swab both nostrils or other orifices of the user.

At 420, the swab may be used to pierce the test tube foil seal to allow the fluid or reagent to be accessed. At 430, the user may continue to push the swab into the test tube until an audible click is head and the swab is fully immersed into the buffer solution. At 440, the test tube and cassette combination may be set aside for a predetermined amount of time, approximately ten minutes. The user may then read the result of the lateral flow medical diagnostic test after the predetermined amount of time.

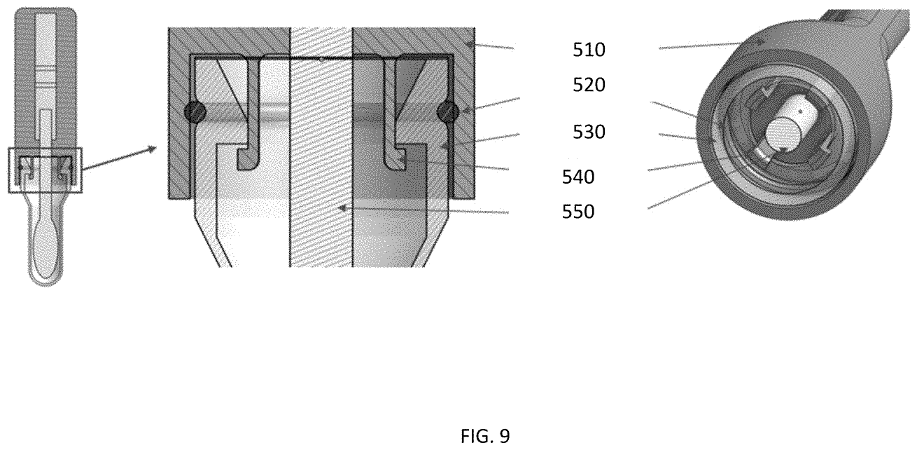

FIG. 9 illustrates an example tamper prevention of a minimum touch cassette design of a lateral flow test kit component. Tamper prevention may be important when users may have the opportunity and incentive to tamper with the test. Specifically, for example, in a telehealth setting the test may be left unattended while the lateral flow reaction is developing. Therefore, a method of preventing the tube from being separated from the cassette may prevent tampering with the reaction. The tampering mechanism may include clips that may latch on to the inside of the test tube. A similar effect may be achieved with clips on the outside of the test tube. This effect may also be achieved with the tampering mechanism including clips on the outside of the test tube or if the cassette attachment is threaded and the threads include a one-way ratchet or other removal resistance mechanism.

As shown in FIG. 9, the cassette 510 may include an outer tube that seals around the test tube 530, and a set of locking arms 540. The test tube 530 may include a lip on the inside. When the test tube is pushed fully into the cassette 501, the locking arms 540 may snap into place, and the tube may no longer be removed. Therefore, because the locking mechanism 540 is inside the cassette 510 and inside the tube 530, it may be difficult to defeat without destroying the device.

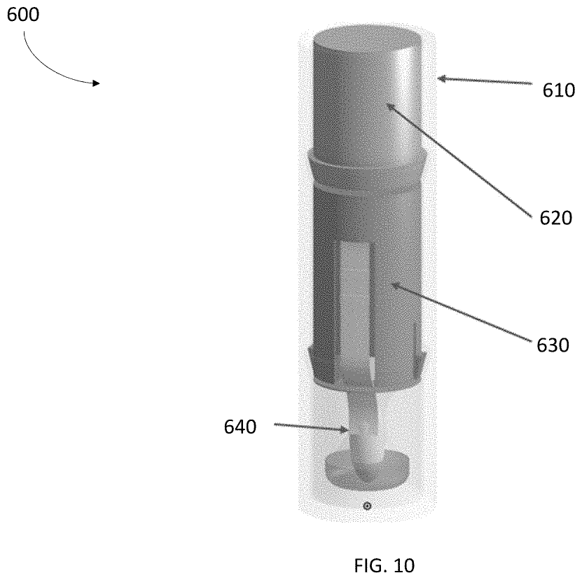

FIG. 10 illustrates an example minimum touch cassette module 600 of a lateral flow test kit component. The minimum touch cassette module 600 may include an outer tube 610. The outer tube 610 may include clear plastic housing and may contain all functional components of the test. For example, a functional component of the test may include the swab handle 620. The swab handle may be easy to hold, and the handle may lock into the body of the out tube 620 for tamper prevention. The minimum touch cassette 600 may further include a spacer with test strip 630. The spacer with test strip 630 may include plastic housing that may hold the strip in place for function and for viewing of the result through the outer tube 610. The minimum touch cassette module 600 may further include a reagent 640 within a container that may be pre-filled with buffer solution and sealed with an adhesive foil cover.

The minimum touch cassette module design may be beneficial for in many aspects. For example, there may only be two physical parts to handle, there may be a limited change that the reagent is spilled accidentally, few steps may be needed to complete the test, the tube design may hold only the required reagent and promote absorption, etc. Similarly, tamper prevention may be incorporated via the locking swab. Additionally, the plastic components may be mass-manufactured, a standard swab or strip may be used, the size of the test may be user friendly (e.g., the test may have a length of approximately three inches long and a diameter of one inch), etc.

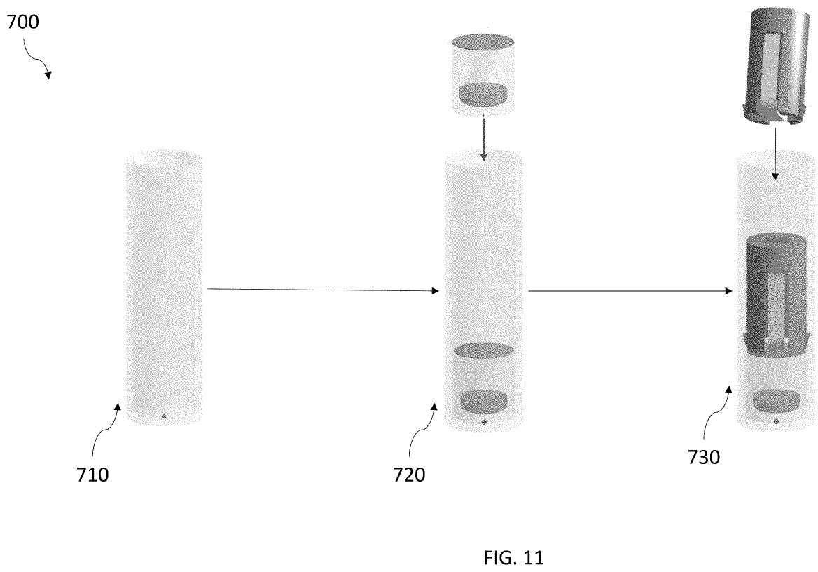

FIG. 11 is a diagram illustrating an example minimum touch cassette module assembly or manufacturing method or protocol 700. The method 700 can be configured to allow a user to assemble a lateral flow medical diagnostic test. The method 700 can be implemented, for example, using one or more components of the method shown in FIG. 7.

At 710, a user may begin assembly of the minimum touch cassette module with the main body of the test. The main body may include a closed end located at the bottom of the main body and an open end located at the top of the main body. The main body may include internal features for snap fitting components.

At 720, the reagent vial may be filled and sealed separately, and then dropped into the main body. At 730, the test strip may be placed in the strip holder and inserted in the main body until it snaps into place.

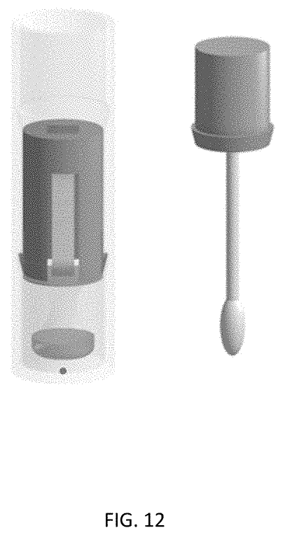

FIG. 12 illustrates components that may be provided in a box that a user may receive. The box may include a test module and the swab assembly. The test module and swab assembly may be packaged separately and then placed in the box.

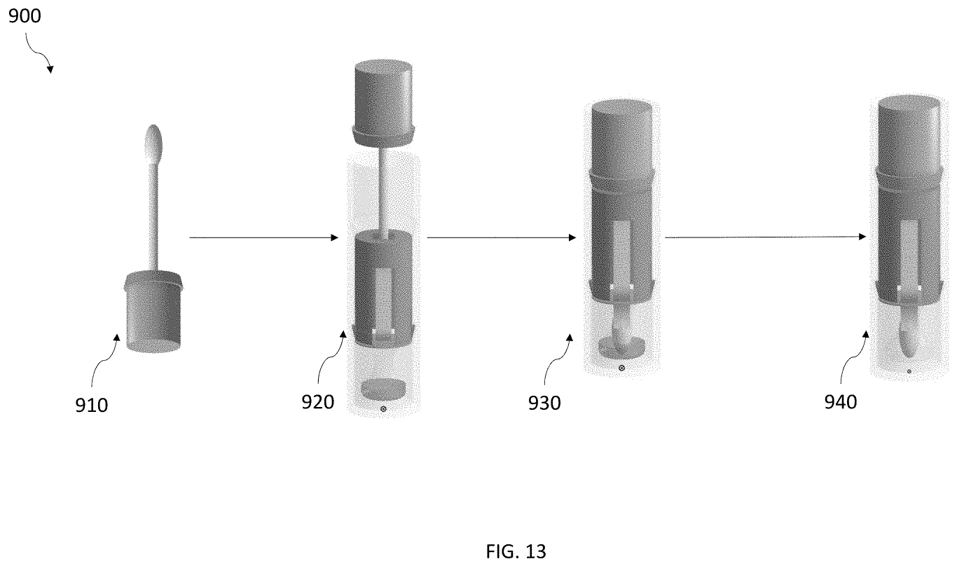

FIG. 13 is a diagram illustrating an example minimum touch cassette module lateral flow test protocol or method 900. The method 900 can be configured to allow a user to administer a lateral flow medical diagnostic test. The method 900 can be implemented, for example, using one or more components of the method shown in FIG. 12.

At 910, the user may remove the swab from the foil pouch and use the swab to swab both nostrils or other orifices. At 920, the user may insert the swab into the open end of the test module and maintain the module in an upright position. This may allow the swab to be immersed in fluid or reagent contained by the test module.

At 930, the user may continue to push the swab into the test module until an audible clock is heard and the swab handle is fully inserted into the test module. At 940, the user may allow the test module to be set aside for a predetermine amount of time, approximately ten minutes. The user may then read the results of the lateral flow test after the predetermined amount of time. The test module may remain in an upright position for the duration of the test.

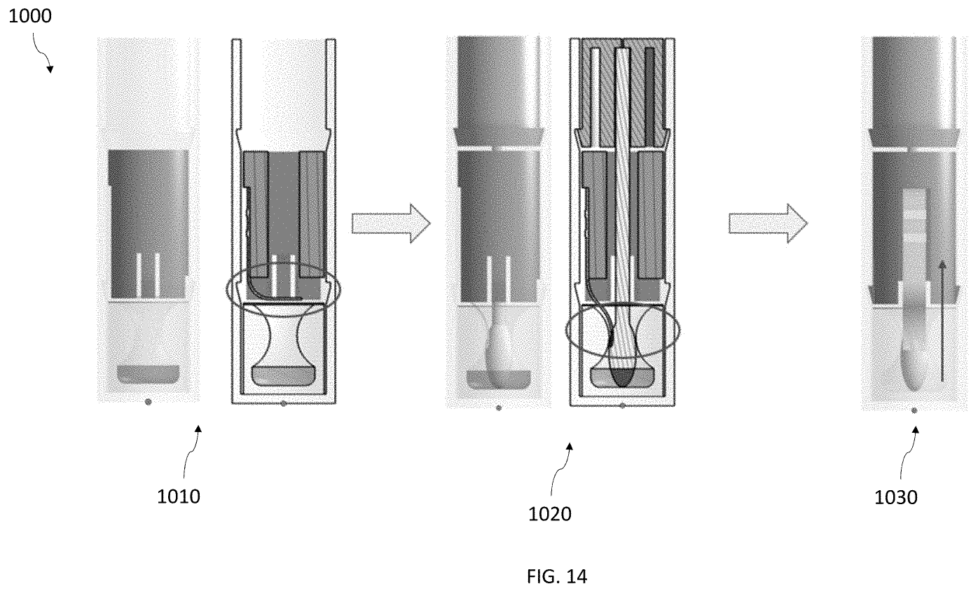

FIG. 14 is a diagram illustrating an example minimum touch cassette module working principal protocol or method 1000. At 1010, the test may be assembled. The test strip may be positioned above the foil seal. At 1020, the swab may be inserted. As the swab pierces the foil seal, the swab pushes the test strip into the reagent vial and pints it against the side of the vial. At 1030, after the swab is inserted, the reagent is absorbed by the swab and dissolves the sample before reaching the test strip. The reagent may then be absorbed by the strip and continues to the lateral flow region.

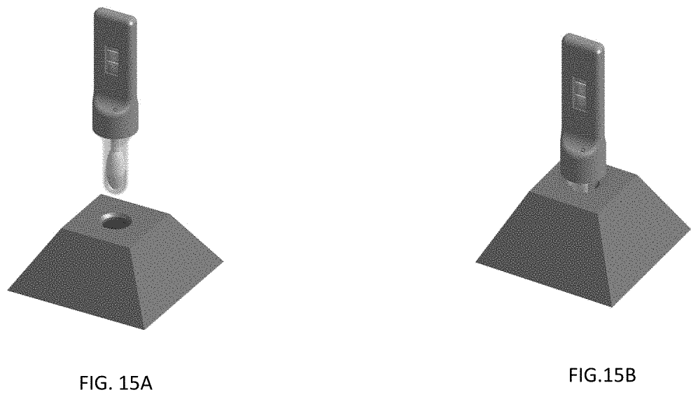

FIG. 15A and FIG. 15B illustrate a support method for the cassette lateral flow test. As shown in the figures, a stand may be used as an accessory. The stand may be a separate piece, or part of the outer box the test may be shipped in as a perforated region. The stand may be part of a cardboard liner inside the test box, as a folded piece with appropriate sized hole. Additionally, the stand may be part of a molded plastic insert that may be included with the test.

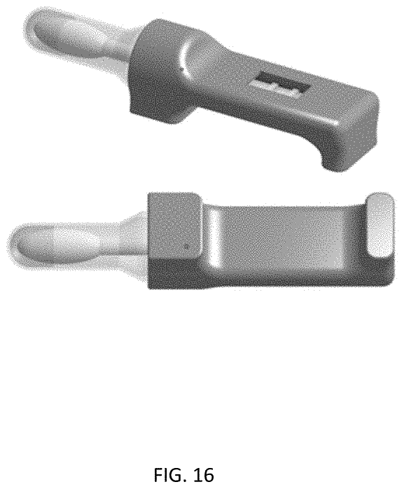

FIG. 16 illustrates a horizonal support method for the cassette lateral flow test. As shown in FIG. 16, the cassette may be modified to include features that allow it to sit horizontally on a flat surface. This may allow the user to easily take images with a mobile device from above the test. Additionally, the protrusions from the cassette may function as a finger grip during swabbing procedure.

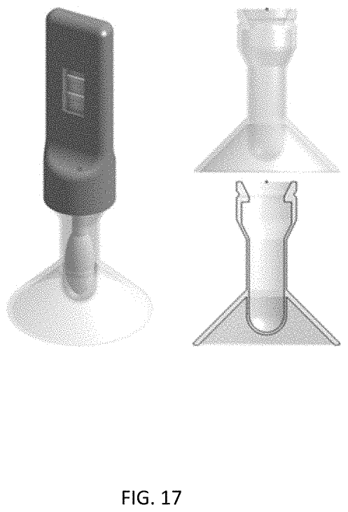

FIG. 17 illustrates a vertical support method for the cassette lateral flow test. As shown in FIG. 17, the test tube may be modified to have a cone shaped skirt that may function as a stand for the device once the test tube is inserted into the cassette.

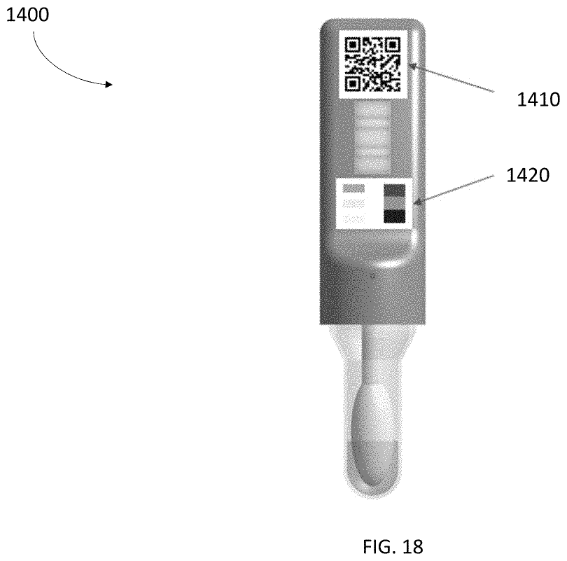

FIG. 18 illustrates an example computer vision enhanced results interpretation mechanism 1400. The mechanism 1400 may include a scannable code for tracking 1410 and a test line and color calibration 1420. Various scannable codes and reference features may be added to the face of the cassette to aid in telehealth by improving image quality and assisting in results interpretation.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than restrictive sense.

Indeed, although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the embodiments of the disclosed invention. Any methods disclosed herein need not be performed in the order recited. Thus, it is intended that the scope of the invention herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and subcombinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is necessary or indispensable to each and every embodiment.

It will also be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one or more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein, but are to be accorded the widest scope consistent with this disclosure, the principles and the novel features disclosed herein.

What is claimed is:

1. A double tube lateral flow test kit device, comprising:
a body extending between a first end and a second end, the body configured to hold a liquid;
a swab extending from the first end of the body;
a lateral flow test strip extending from the second end of the body;
a first tube removably attached to the first end of the body and covering the swab;
a second tube removably attached to the second end of the body and covering the lateral flow test strip;
wherein the first end of the body comprises a first valve that can be selectively opened by a user; and
wherein the second end of the body comprises a second valve that can be selectively opened by the user.

2. The device of claim 1, wherein the first valve and the second valve are each configured to be rotated relative to the body to selectively open the first valve and the second valve, respectively.

3. The device of claim 1, wherein the swab is configured to be inserted into a nostril of the user while the swab is attached to the body.

4. The device of claim 1, further comprising:
a first seal between the first tube and the first end; and
a second seal between the second tube and the second end.

5. The device of claim 4, wherein the first seal and the second seal each comprise an O-ring.

6. The device of claim 1, wherein the swab and the first tube are configured such that, when the first valve is open, the liquid can flow into the first tube and cover a head of the swab.

7. The device of claim 1, wherein the lateral flow test strip and the second tube are configured such that, when the second valve is open, the liquid can flow into the second tube and cover a portion of the lateral flow test strip.

8. A method comprising:
removing a first tube from a first end of a body of a lateral flow test device to expose a swab that extends from the first end of the body;
swabbing a nostril with the swab;
covering the swab with the first tube by reattaching the first tube to the body;
opening a first valve positioned between the body and the first tube to wet the swab with a liquid held within a reservoir of the body;
opening a second valve positioned between the body and a second tube to allow the liquid to flow into the second tube, wherein a lateral flow test strip extends from the second end of the body within the second tube.

9. The method of claim 8, further comprising positioning the lateral flow test device with the first valve open so that the liquid flows from the reservoir, through the first valve, and into the first tube.

10. The method of claim 9, further comprising positioning the lateral flow test device with the second valve open so that the liquid flows from the first tube, through the second valve, and into the second tube.

11. The method of claim 10, wherein the liquid wets the lateral flow test strip in the second tube.

12. A lateral flow test kit device comprising:
a tube including a first end sealed with a cover and a liquid sealed within the tube;
a cassette comprising a body having a lateral flow test strip integrated therein and a swab extending from a first end of the body, wherein the first end of the body is configured to selectively attach to the first end of the tube,
wherein, when the tube is selectively attached to the cassette, the swab extends through the cover and into the liquid within the tube, and the swab is configured to wick the liquid through the swab to the lateral flow test strip.

13. The device of claim 12, wherein the cover comprises a foil seal on the first end of the tube.

14. The device of claim 12, further comprising an O-ring on the first end of the tube that is configured to provide a seal with the first end of the body.

15. The device of claim 12, further comprising a stand configured to support the cassette.

16. The device of claim 15, wherein the stand comprises an opening configured to receive the tube.

17. The device of claim 12, wherein, when the tube is attached to the cassette, the tube is no longer removable from the cassette.

18. A method comprising:
swabbing a nostril with the swab of the device of claim 12;
inserting the swab into the tube by puncturing the cover with the swab, thereby wetting the swab with the liquid;
after a predetermined amount of time, reading a test result from the lateral flow test strip.

19. The method of claim 18, further securing the tube to the body of the cassette.

20. The method of claim 19, further comprising inserting the tube into an opening of a stand to support the device during the predetermined amount of time.
